(19) United States
(12) Patent Application Publication
(10) Pub. No.: US 2010/0220163 A1
(43) Pub. Date: Sep. 2, 2010

(54) Image forming apparatus and image forming method

(75) Inventor: Kazunobu Ohkubo, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,061

(22) Filed: Feb. 24, 2010

(30) Foreign Application Priority Data
Feb. 27, 2009 (JP) 2009-046231

(51) Int. Cl. B41J 2/01

(52) U.S. Cl. 347/102

(57) ABSTRACT

There is provided an image forming device, including: an image forming section that ejects ink droplets based on ink data and forms an image on a recording medium; a liquid adhering section that adheres a transparent liquid to an opposite face of the recording medium to that formed with the image; and a drying section that dries the recording medium that has been formed with the image by the image forming section and has been adhered with the transparent liquid on the opposite face.

### CROSS-REFERENCE TO RELATED APPLICATION

This application claims priority under 35 USC 119 from Japanese Patent Application No. 2009-046231 filed on Feb. 27, 2009, the disclosure of which is incorporated by reference herein.

### BACKGROUND

1. Technical Field

The present invention relates to an image forming apparatus that forms an image by ejecting ink droplets onto a recording medium, and to an image forming method of the same.

2. Related Art

Image forming apparatuses that form an image on a recording medium by ejecting ink droplets from nozzles of a recording head have recently become prevalent.

However, the problem with this type of image forming apparatus is that when curl occurs in the recording medium, the recording medium and the recording head make contact, lowering the quality of the image formed, and blocking the nozzles of the recording head.

In order to solve this problem, technology is described in Japanese Patent Application Laid-Open (JP-A) No. 2005-178252 of an image forming apparatus equipped with a paper conveying section of a recording device, a paper roller, a pair of rollers for conveying the paper, and a head unit further downstream in the conveying direction than the pair of rollers, and a moisture generating section for applying moisture to the paper is provided within the drive roller section, configured by a pair of rollers.

Technology is also described in JP-A No. 2002-361851 relating to an image forming apparatus having feeder means that feeds a sheet, conveying means that conveys the fed sheet, recording means that ejects ink and records an image on the sheet, and a moisture retaining mechanism that is disposed further to the upstream side in the sheet conveying direction than the recording means and retains moisture on the sheet surface.

Technology is also described in JP-A No. 2007-106511 with an image forming apparatus equipped with a conveying belt that conveys a recording medium, a recording head that is disposed above the conveying belt, and humidity detection means that detects the device internal humidity. Moisture is evenly supplied by a coating means to the entire face on the conveying belt side of the recording medium, based on the humidity detected by the humidity detection means, before the recording medium is conveyed by the conveying belt.

Furthermore, technology is described in JP-A No. 2002-187264 relating to an image forming apparatus that, after forming an image on a recording medium using ink, replenishes moisture in a recording medium after it has been dried, in order to correct deformation, such as curl, creases, or the like, of the recording medium that has occurred due to drying the recording medium.

However, in the technologies described JP-A Nos. 2005-178252, 2002-361851, and 2007-106511, whilst moisture is added to the recording medium, there is the problem that curl, occurring in the recording medium due to ink ejected for forming an image, cannot be removed. Furthermore, there is the problem in the image forming apparatus described in JP-A No. 2002-187264 that, since moisture is added to the recording medium after the recording medium has been dried, when the recording medium is then later stacked, the possibility arises that the sheets of recording medium become difficult to separate from each other due to this moisture.

### SUMMARY

The present invention is made to solve the above problems, and an objective is to provide an image forming apparatus and an image forming method that suppress deformation of a recording medium due to ink forming an image, and are suitable to storing a recording medium formed with an image.

In order to achieve the above objective, a first aspect of the present invention provides an image forming device, including:

an image forming section that ejects ink droplets based on ink data and forms an image on a recording medium;

a liquid adhering section that adheres a transparent liquid to an opposite face of the recording medium to that formed with the image, in an amount that corresponds to an ejected amount of ink droplets ejected onto the recording medium based on the image data; and

a drying section that dries the recording medium that has been formed with the image by the image forming section and has been adhered with the transparent liquid on the opposite face.

According to the image forming apparatus of the first aspect of the present invention, ink droplets are ejected based on ink data and an image is formed on a recording medium by the image forming section, transparent liquid is adhered to the opposite face of the recording medium to that formed with the image by the liquid adhering section, and the recording medium, formed with an image and adhered with the transparent liquid on the opposite face, is dried by the drying section.

By so doing, according to the image rendering processing apparatus of the first aspect of the present invention, deformation of a recording medium, due to ink forming an image, can be suppressed, and a suitable state for storing a recording medium formed with an image can be achieved.

A second aspect of the present invention provides the image forming device of the first aspect, wherein the liquid adhering section comprises one of:

a spray that spays the transparent liquid in a mist state;

a sponge impregnated with the transparent liquid; or

a roller with the transparent liquid adhered to a surface thereof.

A third aspect of the present invention provides the image forming device of the first aspect, wherein the drying section dries both faces of the recording medium.

A fourth aspect of the present invention provides the image forming device of the fifth aspect, wherein the drying section blows warm air against the face of the recording medium formed with the image such that the warm air is drawn around to the opposite face of the recording medium.

In order to achieve the above objective, a fifth aspect of the present invention provides an image forming method, including:

ejecting ink droplets based on image data and forming an image on a recording medium;

adhering a transparent liquid to an opposite face of the recording medium to that formed with the image, in an amount corresponding to an ejected amount of the ink droplets ejected onto the recording medium based on the image data; and

drying the recording medium that has been formed with an image and has been adhered with the transparent liquid on the opposite face to that formed with the image.

Consequently, according to the image forming method of the seventh aspect of the present invention, in a similar manner to in the first aspect of the present invention, deformation of a recording medium, due to ink forming an image, is suppressed, and a suitable state for storing a recording medium formed with an image can be achieved.

As explained above, according to the present invention, an excellent effect is exhibited in that deformation of a recording medium, due to ink forming an image, can be suppressed, and a suitable state for storing a recording medium formed with an image can be achieved.

### BRIEF DESCRIPTION OF THE DRAWINGS

Exemplary embodiments of the present invention will be described in detail based on the following figures, wherein:

FIG. 1 is a cross-section side view showing a configuration of an inkjet recording device according to an exemplary embodiment;

FIG. 2 is a plan view of an image forming section according to an exemplary embodiment, and the periphery thereof;

FIG. 3 is a diagram showing an external configuration of a liquid adhering section according to an exemplary embodiment;

FIG. 4 is a cross-section side view showing a configuration of a drying section according to an exemplary embodiment;

FIG. 5 is a block diagram showing some main parts of the configuration of an electrical system of an inkjet recording device according to an exemplary embodiment;

FIG. 6 is a flow chart showing a processing flow of an image forming program according to an exemplary embodiment;

FIG. 7 is a diagram showing an image forming face of recording paper formed with an image and a back face of the recording paper to which water has been adhered, using an inkjet recording device according to an exemplary embodiment;

FIG. 8A and FIG. 8B are diagrams showing configurations of liquid adhering sections according to other embodiments; and

FIG. 9 is a cross-section side view showing a configuration of a drying section according to another embodiment.

### DETAILED DESCRIPTION

A detailed explanation will now be given regarding an exemplary embodiment of the present invention, with reference to the drawings. Note that explanation is given here of a case where the present invention is applied to an inkjet recording device.

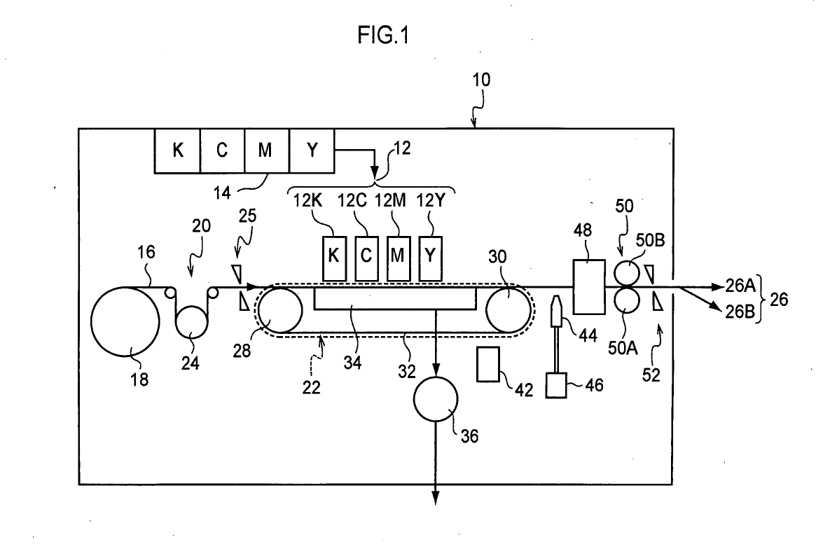

FIG. 1 shows an overall configuration of an inkjet recording device 10 according to the present exemplary embodiment.

As shown in the drawing, the inkjet recording device 10 includes: an image forming section 12 that has plural ink jet recording heads (referred to as “heads” below) 12K, 12C, 12M, 12Y provided to correspond to the respective inks black (K), cyan (C), magenta (M), and yellow (Y); an ink storage and filling section 14 that stores ink for supply to each of the respective heads 12K, 12C, 12M, 12Y; a paper supply section 18 that supplies a recording medium that is recording paper 16; a de-curling section 20 that removes any curl in the recording paper 16; a belt conveying section 22 that is disposed facing the nozzle face (ink ejection face) of the image forming section 12 and conveys the recording paper 16 while maintaining the recording paper 16 in a flat state; and a paper discharge section 26 that externally discharges recording paper which has been recorded on (printed matter).

The ink storage and filling section 14 has ink tanks for storing ink of colors corresponding to each of the respective heads 12K, 12C, 12M, 12Y, and each of the tanks is in communication with the respective heads 12K, 12C, 12M, 12Y through its own tube path. Furthermore, the ink storage and filling section 14 is equipped with a notification section that notifies when only a small amount of ink remains and has functionality to prevent misfilling between the colors.

An example of a magazine of roll-paper (continuous paper) for the paper supply section 18 is shown in FIG. 1, however plural magazines of different paper widths, paper qualities, or the like, may be used in combination. Furthermore, paper may be supplied with a cassette stacked with cut paper in place of, or in combination with, the magazine of roll-paper.

Note that when a configuration is made enabling plural types of recording paper 16 to be used, a data storage body, such as a bar-code, wireless tag, or the like, stored with type data of the recording paper 16 is preferably attached to the magazines, and by reading out the data of the data storage body with a specific reading device, the type of the recording paper 16 for use is automatically determined, with ink ejection control performed such that appropriate ink ejection is performed for the type of paper in use.

The recording paper 16 feed out from the paper supply section 18 has a residual curl tendency due to having been stored in the magazine, and is curled. In order to remove such a curl, in the de-curling section 20 heat is applied with a heat application drum 24 to the recording paper 16 that is looped around in the opposite direction to the curl tendency of the magazine. When this is carried out, preferably control is made of the heat application temperature such that the face of the recording paper 16 that is going to be formed with an image (referred to below as the “image forming face”) ends up with a slight curl toward the outside.

When device configuration is made employing roll-paper, as shown in FIG. 1, a cutter 25 is provided for chopping, and the roll-paper is cut to the desired size with the cutter 25. The cutter 25 is not required when cut paper is employed.

After de-curling, the recording paper 16 that has been cut with the cutter 25 is fed toward the belt conveying section 22.

The belt conveying section 22 is configured with so as to have a structure with an endless belt 32 entrained between rollers 28 and 30. The belt 32 moves in the clockwise direction shown in FIG. 1 by a transmission of power from a non-illustrated motor to at least one of the rollers 28 and 30, around which the belt 32 is entrained, and the recording paper 16 that is retained on the belt 32 is conveyed from the left hand side of FIG. 1 to the right hand side.

Note that the belt 32 has a width dimension that is wider that the width of the recording paper 16, and there are multiple suction holes (not shown in the drawings) formed on the belt surface. As shown in FIG. 1, there is a suction chamber 34 provided at the inside of the belt 32 entrained between the rollers 28 and 30, at a position that faces the ink ejection face described above, and the recording paper 16 is attracted onto the belt 32, by suctioning with a fan 36 and making the air in the suction chamber 34 at a negative pressure, and then the recording paper 16 is retained there. Note that in the inkjet recording device 10 according to the present exemplary embodiment is of a configuration in which the recording paper 16 is retained on the belt 32, and a suctioning attraction method is employed utilizing the suction chamber 34, however there is no limitation thereto, and a configuration in which the recording paper 16 is electrostatically attracted onto the belt 32, using a static electricity attraction method, may be employed.

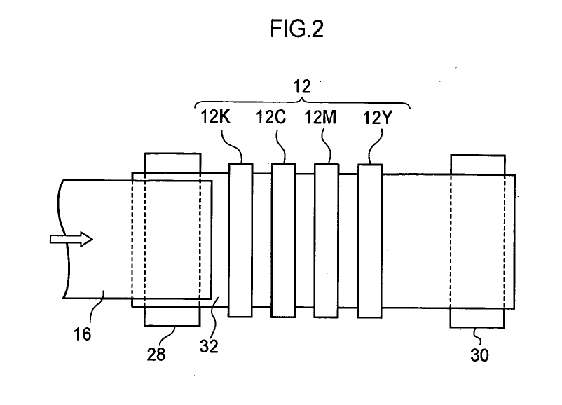

Each of the heads 12K, 12C, 12M, 12Y of the image forming section 12 is a full-line head (see FIG. 2), having a length that corresponds to the maximum width of the recording papers 16 for use in the inkjet recording device 10, and having plural nozzles for use in ink ejection arrayed on the nozzle faces of the heads 12K, 12C, 12M, 12Y over a length (total width of the image renderable range) that at least exceeds the length of one side of the maximum size of the recording paper 16.

The heads 12K, 12C, 12M, 12Y are disposed along the conveying direction of the recording paper 16 in the color sequence from the upstream side of black (K); cyan (C), magenta (M), and yellow (Y), and each of the respective heads 12K, 12C, 12M, 12Y is installed fixed so as to extend along a direction that is substantially orthogonal to the conveying direction of the recording paper 16.

As the recording paper 16 is being conveyed by the belt conveying section 22, different colors of ink are ejected from the respective heads 12K, 12C, 12M, 12Y onto the recording paper 16 so as to form a color image.

In this manner, by having a configuration with the full line heads 12K, 12C, 12M, 12Y that have nozzle rows covering the entire region of the paper width and are provided for each separate color, an image can be recorded on the whole face of the recording paper 16 by a single time relative movement of the recording paper 16 with respect to the image forming section 12 (namely a single time in the slow scanning direction) in the paper feed direction (referred to below as the “paper conveying direction” or the “slow scanning direction”). Faster printing is thereby enabled in comparison to recording heads of a shuttle type in which the recording heads move too-and-fro in a direction orthogonal to the paper conveying direction, and productivity therefore be raised.

The present example shows an example of a configuration with the standard colors of KCMY (4 colors), however the ink colors, number of colors, and combinations are not limited to those of the present exemplary embodiment, and pale color inks, deep color inks, and spot color inks may be added according to need. For example, a configuration is possible in which inkjet heads are added for ejecting light inks, such as for light cyan, light magenta, or the like. Furthermore, there is no particular limitation to the sequence in which the respective colors of head are disposed.

Furthermore, since there are instances in which ink droplets ejected from the image forming section 12 adhere to the belt 32, a belt cleaning section 42 is provided, outside of the region of the belt 32 where the recording paper 16 is conveyed. Note that in the inkjet recording device 10 according to the present exemplary embodiment, brush rolls are employed as the belt cleaning section 42, however there is no limitation thereto, and a water absorbent roll, an air blower that blows cleaning air against the belt 32, or a combination thereof or the like may be employed.

A liquid adhering section 44 that adheres a transparent liquid onto the opposite face to the image forming face of the recording paper 16 (referred to below as the “back face”) is provided further to the downstream side in the paper conveying direction than the belt conveying section 22. Note that in the liquid adhering section 44 according to the present exemplary embodiment the transparent liquid is water, however another liquid may be employed as long as it is a transparent liquid after drying that does not denature the recording paper 16. This water is stored in a liquid storage section 46 and supplied to the liquid adhering section 44.

Furthermore, the liquid adhering section 44 according to the present exemplary embodiment is formed as a sprayer that ejects the water in a mist state.

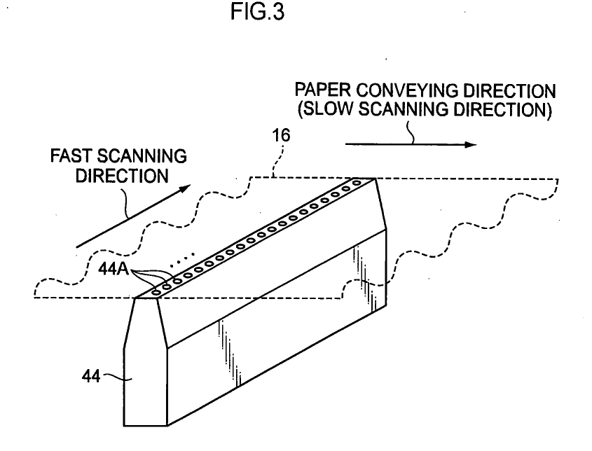

More specifically, as shown in FIG. 3, the liquid adhering section 44 according to the present exemplary embodiment has a length that corresponds to the maximum width of the recording paper 16 conveyed, and plural nozzles 44A are arrayed facing the back face of the recording paper 16 along a direction orthogonal to the slow scanning direction (referred to below as the “fast scanning direction”), with the same amount of water being ejected in a mist state onto the back face of the recording paper 16 from each of the nozzles 44A. Note that the number of rows of the nozzles 44A in the liquid adhering section 44 according to the present exemplary embodiment is a single row, however there is no limitation to a single row, with plural rows being possible.

Furthermore, there is a drying section 48 provided further to the downstream side in the paper conveying direction than the liquid adhering section 44, the drying section 48 drying both sides of the recording paper 16 that has become damp from the ink ejected from the image forming section 12, and from the water adhered by the liquid adhering section 44.

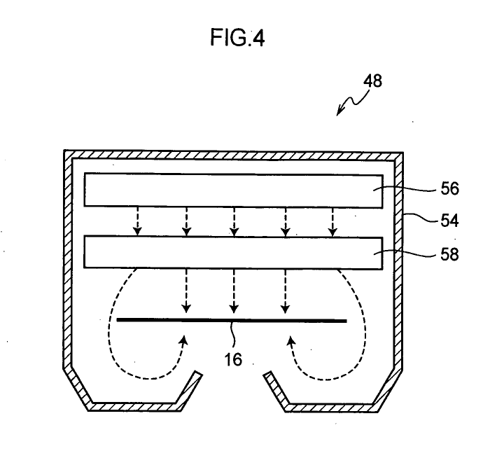

FIG. 4 shows a schematic configuration of a drying section 48 according to the present exemplary embodiment.

In the drying section 48 according to the present exemplary embodiment, a fan 56 that blows air is provided within a casing 54, and a heater 58 that applies heat to the air blown by the fan 56 is provide downstream of the fan 56 in the casing 54. Warm air is blown at the recording paper 16 conveyed at the bottom side of the heater 58. Note that the conveying direction of the recording paper 16 is a direction vertically out of the face of the paper in FIG. 4.

The bottom side of the casing 54 is folded back on itself toward the back face of the recording paper 16. The warm air that is being blown against the image forming face of the recording paper 16 is redirected around and onto the back face of the recording paper 16 by this folding back, evaporating the liquid component of the ink droplets ejected onto the recording paper 16 and also the water that has been adhered to the recording paper 16, and drying both faces of the damp recording paper 16.

A heat and pressure application section 50 is provided at the paper conveying direction downstream side of the drying section 48. The heat and pressure application section 50 presses, with a pressure roller 50B, while applying heat to the image forming face with a heat application roller 50A.

The printed matter generated is then discharged from the paper discharge section 26. Note that preferably the printed matter of the actual image to be printed (matter printed with the image subject), and any printed matter of text printouts, are preferably separated for discharge. In the inkjet recording device 10 according to the present exemplary embodiment, a non-illustrated selection section is provided that switches discharge paths in order to select the printed matter of the actual image or the printed matter of text printouts and send them to the respective discharge sections 26A, 26B.

Note that when the actual image and text printouts are formed in parallel at the same time on over-sized paper, the portion of the text printout is separated by a cutter 52. Furthermore, while not shown in the drawings, a sorter is provided in the discharge section 26A for the actual images to stack images separated according to orders.

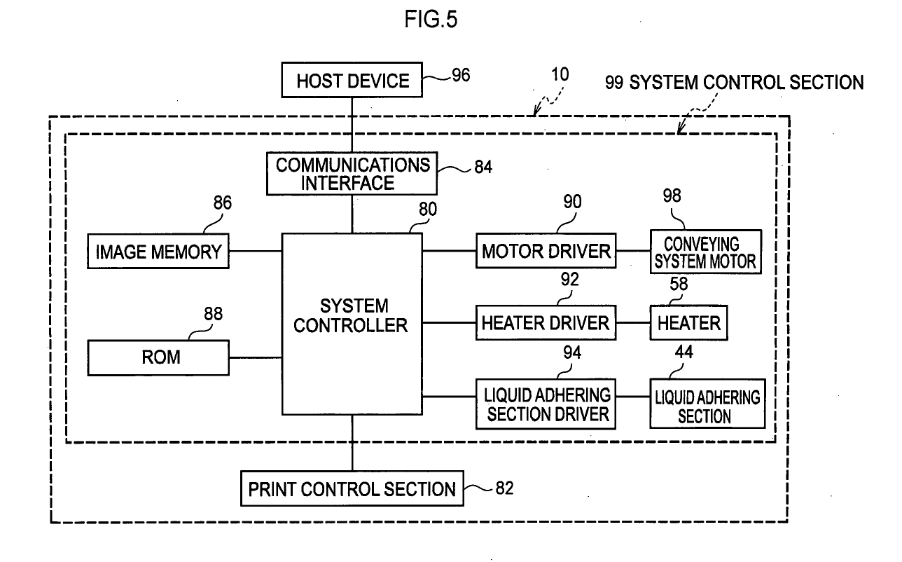

FIG. 5 is a block diagram showing an electrical configuration of the inkjet recording device 10. As shown in FIG. 5, the inkjet recording device 10 is equipped with a system controller 80, a print control section 82, a communications interface 84, an image memory 86, a Read Only Memory (ROM) 88, a motor driver 90, a heater driver 92, and a liquid adhering section driver 94.

The system controller 80 is configured from a Central Processing Unit (CPU), a peripheral circuit thereof, or the like, and the system controller 80 functions as a control device that controls the inkjet recording device 10 as a whole, according to a specific program, as well as functioning as a computation device that performs various types of computation. Namely, the system controller 80 controls each of the sections of the print control section 82, the communications interface 84, the image memory 86, the ROM 88, the motor driver 90, the heater driver 92, and the liquid adhering section driver 94, controls communication with a host device 96, performs control of reading from and writing to the image memory 86, the ROM 88 and the like, and generates control signals for controlling a conveying system motor 98, the liquid adhering section 44, and the heater 58 of the drying section 48. Note that when control is performed to the print control section 82 for forming the image on the recording paper 16, various types of data are transmitted, such as image data stored in the image memory 86, and the like.

The communications interface 84 is an interface section with the host device 96 that is employed when a user gives image forming instructions to the inkjet recording device 10 and the like, and the communications interface 84 is installed with a buffer memory in order to raise the speed of communication. Note that while in the inkjet recording device 10 according to the present exemplary embodiment a Universal Serial Bus (USB) is employed as the communications interface 84, there is no limitation thereto, and a serial interface, such as one according to Institute of Electrical and Electronics Engineers (IEEE) 1394, Ethernet (registered trademark), a wireless network or the like, or a parallel interface such as Centronics or the like, may be employed.

The image memory 86 is a storage section that stores image data that has been transmitted from the host device 96 through the communications interface 84, and the like, and readout and writing of various data is performed through the system controller 80. The image memory 86 is utilized as a temporary storage region for various data, and is also utilized as an expansion region for a program and as CPU computation work space. Note that while in the inkjet recording device 10 according to the present exemplary embodiment a memory formed from a semiconductor device is used as the image memory 86, there is no limitation thereto, and a magnetic medium, such as a hard disk or the like, may be employed.

Programs for execution by the CPU of the system controller 80, and various data required for control, and the like are stored on the ROM 88. Note that while in the inkjet recording device 10 according to the present exemplary embodiment a non-rewritable storage section is employed as the ROM 88, there is no limitation thereto, and a re-writable storage section, such as an Electrically Erasable Programmable Read Only Memory (EEPROM) or the like, may be employed therefore.

The motor driver 90 is a drive circuit for driving the conveying system motor 98 according to instructions from the system controller 80, and the heater driver 92 is a driver for driving the heater 58 of the drying section 48 according to instructions from the system controller 80. The liquid adhering section driver 94 is a driver for driving the liquid adhering section 44 according to instructions from the system controller 80.

The print control section 82 functions as a signal processing section that performs various types of processing, correction and the like, according to control from the system controller 80, in order to generate a signal used in ejection control from the image data transmitted from a system control section 99. The print control section 82 also controls ejection driving of the image forming section 12 based on the generated ink ejection data.

Note that in a conventional inkjet recording device 10, when ink droplets are ejected in order to form an image on the recording paper 16, deformation, such as curl, creases or the like, is generated in the recording paper 16 due to the ejected ink droplets. Then, this deformation is set-in by performing drying to dry the recording paper 16, with the possibility that the recording paper 16 will remain in the deformed state.

However, in the inkjet recording device 10 according to the present exemplary embodiment, image forming processing is executed in which, after forming an image on the image forming face of the recording paper 16, water is adhered to the back face of the recording paper 16 by the liquid adhering section 44, and then the recording paper 16 is dried.

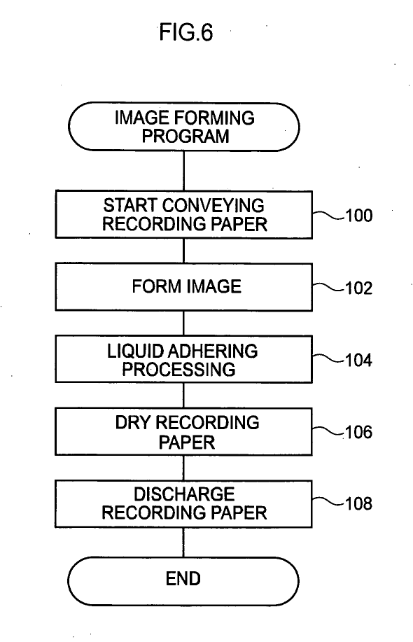

Explanation will now be given of the operation of the inkjet recording device 10 according to the present exemplary embodiment, with reference to FIG. 6. Note that FIG. 6 is a flow chart showing the flow of an image forming program executed by the system controller 80 when image data is transmitted to the inkjet recording device 10 via the host device 96 and an execution instruction for image forming processing has been entered. The image forming program is stored in advance in a predetermined region of the ROM 88 that is a storage medium.

First, at step 100, conveyance of the recording paper 16 is started by driving the conveying system motor 98 through the motor driver 90.

At step 102, based on image data, via the print control section 82, ink droplets are ejected by the image forming section 12 onto the image forming face of the recording paper 16 that has arrived at the image forming position, a position facing the image forming section 12, and an image is formed.

At the next step 104, the recording paper 16 that has been formed with an image on the image forming face thereof, is conveyed to a liquid adhering position, a position facing the liquid adhering section 44. Processing (referred to below as “liquid adhering processing” is executed, via the liquid adhering section driver 94, for adhering water by ejecting water in a mist state from the nozzles 44A of the liquid adhering section 44 onto the back face of the recording paper 16 that has arrived at the liquid adhering position.

Note that the amount of water adhered to the back face of the recording paper 16 is an amount corresponding to the ejected amount of ink droplets that have been ejected onto the recording paper 16 based on the image data. Namely, the amount of water adhered to the back face of the recording paper 16 varies according to the amount of ink that is ejected onto the image forming face thereof.

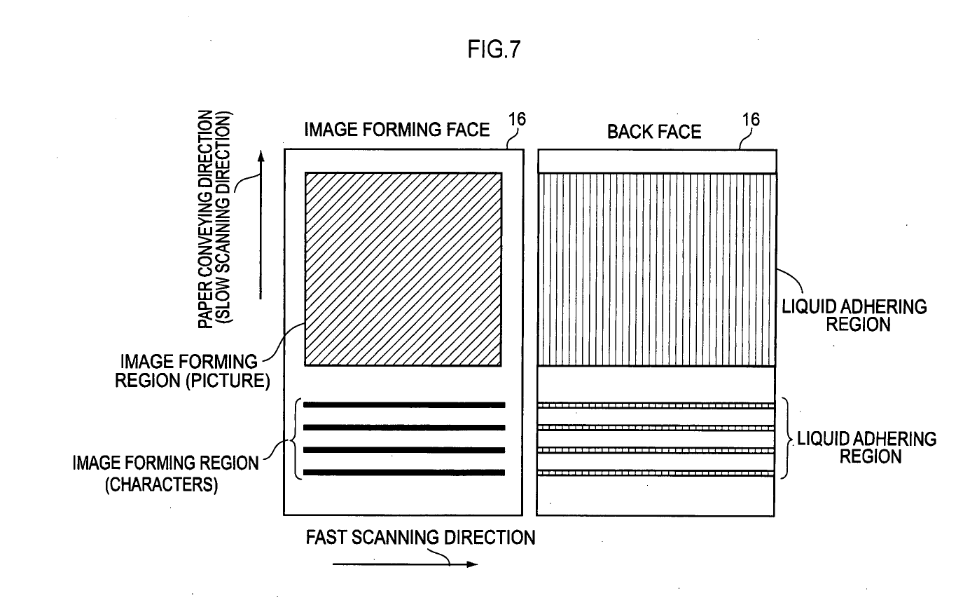

FIG. 7 shows, as an example, the recording paper 16 to which an image, representing a figure and some characters, has been formed on the image forming face thereof, and water has been adhered in a region of the back face (referred to below as the “liquid adhering region”) that corresponds to the region formed with the image on the image forming face (referred to below as the “image forming region”).

As shown in FIG. 7, while the liquid adhering section 44 adheres water to the region of the back face corresponding to the image forming region, it does not adhere water to regions of the back face outside of the image forming region.

Note that in the inkjet recording device 10 according to the present exemplary embodiment, as a method for deriving the amount of water to be ejected from each of the nozzles 44A, the total amount of the ejection amount of ink droplets is derived, based on the image data, for each section along the fast scanning direction of the recording paper 16, of a specific width in the slow scanning direction (width in the slow scanning direction for adhering water to the recording paper 16 by ejection a single time from the nozzles 44A), and the total amount that has been derived is employed in a method of averaging across the respective number of the nozzles 44A. Furthermore, the timing for ejecting water from the nozzles 44A, and the amount of water for ejection, is adjusted according to the conveying speed of the recording paper 16.

Furthermore, in the liquid adhering section 44 according to the present exemplary embodiment, water of an amount in accordance with the moisture absorbing ability of the recording paper 16 is adhered to the back face of the recording paper 16. Namely, for recording paper 16 of high moisture absorbing ability, a comparatively small amount of water is adhered to the back face of the recording paper 16 compared to the amount of water adhered to recording paper 16 of low moisture absorbing ability.

More specifically, the amount of water adhered to the recording paper 16 is experimentally derived in advance according to the moisture absorbing ability of the recording paper 16. Then adhering amount data indicating the amount of water for adhering to each of the types of recording paper 16 of differing moisture absorbing ability is stored on the ROM 88, and when water adhering processing is executed, the amount of water to be adhered by the liquid adhering section 44, namely the ejection amount of water from the nozzles 44A, is adjusted according to the type of recording paper 16 and based on the adhering amount data. Note that when a data storage body is attached to a magazine of roll-paper, the adhering amount data is associated with the data indicted by the data storage body, and the adhering amount data is selected according to the type of recording paper 16 by reading the data storage body. Furthermore, when there is no data storage body attached to the magazine of roll-paper, for example, a user selects, via the host device 96, the adhering amount data according to the type of recording paper 16.

It is also desirable to employ recording paper that has equivalent moisture absorbing ability on the image forming face and on the back face for the recording paper 16.

In the next step 106, the recording paper 16 that has had an image formed on the image forming face and water adhered to the back face is conveyed to the drying section 48, and both faces of the recording paper 16 that has arrived at the drying section 48 is dried by means of the heater driver 92.

In this manner, by drying the recording paper 16 after performing the above liquid adhering processing, the residual stress generated by the ejected ink droplets on the image forming face, and the residual stress generated by the water adhered to the back face, cancel each other out, and occurrences of deformation in the recording paper 16 can be suppressed.

At the next step 108, the recording paper 16 is discharged to the discharge section 26A, and the current routine is ended.

As explained in detail above, the inkjet recording device 10 according to the present exemplary embodiment, ejects ink droplets based on image data and forms an image on the recording paper 16 with the image forming section 12, adheres a transparent liquid (in this case water) to the recording paper 16, on the opposite face to the face formed with the image, with the liquid adhering section 44, and dries the recording paper 16 that has been formed with an image and has had a transparent liquid adhered to the opposite face thereof, with the drying section 48. Thereby, deformation of the recording medium due to the ink forming the image can be suppressed, and a state can be achieved that is suitable for storing a recording medium formed with an image.

Furthermore, since the liquid adhering section 44 applies an amount of the transparent liquid to the above opposite face of the recording paper 16 in accordance with the ejection amount of ink droplets ejected onto the recording paper 16 based on the image data, deformation of the recording medium can be even more effectively suppressed.

Furthermore, the liquid adhering section 44 applies water, of an amount in accordance with the moisture absorbing ability of the recording paper 16, to the opposite face of the recording paper 16, therefore deformation of the recording medium can be even more effectively suppressed.

Furthermore, the liquid adhering section 44 sprays the transparent liquid in a mist state, and therefore water can be adhered to the recording medium with a simple configuration.

The drying section 48 dries both faces of the recording paper 16, therefore the liquid component in the ink droplets ejected onto the recording medium, as well as the transparent liquid adhered to the recording medium, can be evaporated.

Furthermore, since the drying section 48 blows warm air onto the face of the recording paper 16 formed with the image such that the warm air is drawn around to the opposite face of the recording paper 16, both faces of the recording medium can be dried with a simple configuration.

Explanation has been given by way of the above exemplary embodiment, however the technical scope of the present invention is not limited to the scope of the exemplary embodiment described above. Various modifications and improvements can be made to the above exemplary embodiment within a scope that does not depart from the spirit of the invention, and such modifications and improvements are included within the technical scope of the present invention.

Not all combinations of the features explained in the exemplary embodiment above are necessarily required to solve the problem of the invention. Various steps of invention are included in the exemplary embodiment explained above, and various inventions can be derived by combining plural configuration features disclosed. Even if given configuration feature(s) are removed from the total configuration features shown in the above exemplary embodiment, as long as an effect can be achieved, a configuration with these given configuration feature(s) removed can be derived as the invention.

For example, in the above exemplary embodiment, the explanation was given of a case where the amount of water ejected from each of the nozzles 44A of the liquid adhering section 44 each time was the same for each of the nozzles 44A, however the present invention is not limited thereto, and configuration may be made in which the amount of water ejected from each of the nozzles 44A each time is varied, and the amount of water adhered to the back face is changed in the fast scanning direction based on the image data.

Furthermore, in the above exemplary embodiment, explanation was given of a case, based on the image data, having a region to which water was adhered on the back face of the recording paper 16 and regions to which water was not adhered, however the present invention is not limited thereto. An embodiment may be employed in which the total amount of ink employed for forming the image is determined, based on the image data, and water of an amount that corresponds to the determined total amount is adhered uniformly as an average over the entire region of the back face of the recording paper 16.

Furthermore, explanation was given in the above exemplary embodiment of a case where the liquid adhering section 44 was sprayed, however the present invention is not limited thereto. Embodiments in which the liquid adhering section 44 has a sponge impregnated with water, or a roller with water adhered to the surface, may also be employed.

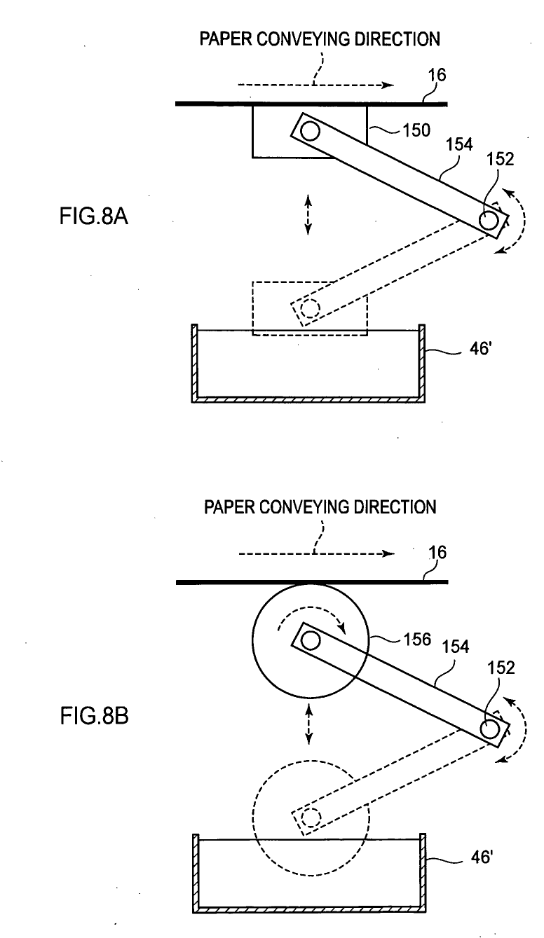

FIG. 8A is a configuration diagram showing the liquid adhering section 44 with a sponge 150.

The sponge 150 is attached to one end of an elongated shaped support member 154 that has the other end supported by a rotation shaft 152, and the sponge 150 is moved up and down relative to the back face of the recording paper 16 by rotational movement of the support member 154 about the rotation shaft 152 as the center, adhering water to the back face of the recording paper 16 by upward movement of the sponge 150. There is a liquid storage section 46′ storing water provided below the sponge 150, enabling water to be impregnated into the sponge 150 by downward movement.

FIG. 8B is a configuration diagram of a case showing the liquid adhering section 44 with a roller 156.

The roller 156 is also attached to one end of an elongated shaped support member 154 that has the other end supported by a rotation shaft 152, and the roller 156 is moved up and down relative to the back face of the recording paper 16 by rotational movement of the support member 154 about the rotation shaft 152 as the center, adhering water to the back face of the recording paper 16 by upward movement. A liquid storage section 46′ is provided below the roller 156 and enables the surface of the roller 156 to be adhered with water. Note that the roller 156 is rotatable so as to follow conveying of the recording paper 16. The roller 156 may also be of a spongy substance so that water can be impregnated into the roller 156.

Note that the length of the sponge 150 and the roller 156 correspond to the maximum paper width of conveyed recording paper 16, however modified embodiments may be made in which the sponge 150 or the roller 156 are formed separated into plural sections in the fast scanning direction, with each of the sections moved up and down separately, with the amount of water adhered to the back face varying along the fast scanning direction.

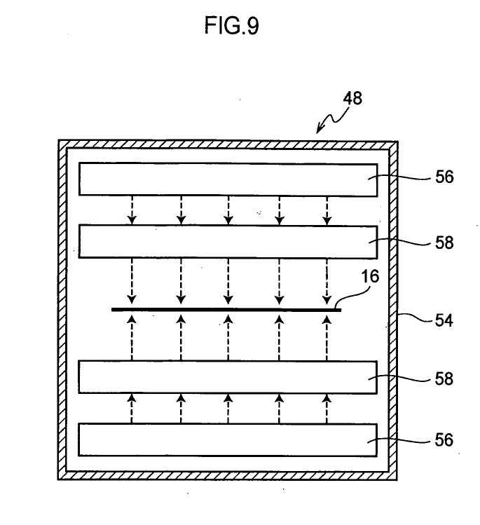

In the above exemplary embodiment, explanation has been given of a case in which the fan 56 of the drying section 48 and the heater 58 are positioned facing the image forming face, however the present invention is not limited thereto. As shown in FIG. 9, an embodiment may be made with two of the fans 56 of the drying section 48 and two of the heaters 58 provided at positions facing the image forming face and the back face, respectively.

Furthermore, in the above exemplary embodiment, explanation has been given of a case in which an image was only formed to the image forming face, this being the front face, however the present invention is not limited thereto. One of the image forming sections 12 may also be provided at the back face, an embodiment that enables images to be formed to both faces of the recording paper 16 (so-called double-sided printing).

In such an embodiment, the inkjet recording device 10 does not perform liquid adhering when images are formed to both faces of the recording paper 16, and performs liquid adhering processing to the back face when images are only formed to the front face of the recording paper 16.

In addition, the configuration of the inkjet recording device 10 explained in the above exemplary embodiment (see FIG. 1 to FIG. 5) is only an example thereof, and obviously portions that are not required can be removed therefrom, and additional portions can be added thereto, within a scope not departing from the spirit of the invention.

Furthermore, the processing flow of the image forming program explained in the above exemplary embodiment (see FIG. 6) is also only an example thereof, and steps that are not required can be removed therefrom, new steps can be added thereto, and the processing sequence can be changed, within a scope not departing from the spirit of the invention.

What is claimed is:

1. An image forming device, comprising:
an image forming section that ejects ink droplets based on ink data and forms an image on a recording medium;
a liquid adhering section that adheres a transparent liquid to an opposite face of the recording medium to that formed with the image, in an amount that corresponds to an ejected amount of ink droplets ejected onto the recording medium based on the image data; and
a drying section that dries the recording medium that has been formed with the image by the image forming section and has been adhered with the transparent liquid on the opposite face.

2. The image forming device of claim 1, wherein the liquid adhering section comprises one of:
a spray that spays the transparent liquid in a mist state;
a sponge impregnated with the transparent liquid; or
a roller with the transparent liquid adhered to a surface thereof.

3. The image forming device of claim 1, wherein the drying section dries both faces of the recording medium.

4. The image forming device of claim 3, wherein the drying section blows warm air against the face of the recording medium formed with the image such that the warm air is drawn around to the opposite face of the recording medium.

5. An image forming method, comprising:
ejecting ink droplets based on image data and forming an image on a recording medium;
adhering a transparent liquid to an opposite face of the recording medium to that formed with the image, in an amount corresponding to an ejected amount of the ink droplets ejected onto the recording medium based on the image data; and
drying the recording medium that has been formed with an image and has been adhered with the transparent liquid on the opposite face to that formed with the image.
